(19) United States
(12) Patent Application Publication
(10) Pub. No.: US 2015/0238892 A1
(43) Pub. Date: Aug. 27, 2015

(54) ADSORBENT MIXTURE INCLUDING ADSORBENT PARTICLES AND PHASE CHANGE MATERIAL PARTICLES

(71) Applicant: L'AIR LIQUIDE,SOCIETE ANONYME POUR L'ETUDE ET L'EXPLOITION DES PROCEDES GEORGES CLAUDE, Paris (FR)

(72) Inventors: Christian Monereau, Montpellier (FR); Pluton Pullumbi, Versailles (FR); Vincent Gueret, Hangzhou (CN)

(21) Appl. No.: 14/430,049

(22) PCT Filed: Sep. 18, 2013
(86) PCT No.: PCT/FR2013/052145

§ 371 Date: Mar. 20, 2015

(30) Foreign Application Priority Data
Sep. 21, 2012 (FR) 1258890

(51) Int. Cl. B01D 53/047; B01J 20/28

(52) U.S. Cl. CPC B01D 53/047; B01J 20/28016; B01J 20/28042; B01D 2253/302; B01D 2253/116; B01D 2257/108; B01D 2257/504; B01D 2257/104; B01D 2257/102; B01D 2257/502; B01D 2257/7025; B01J 20/28004

(57) ABSTRACT

Adsorbent mixture comprising:
adsorbent particles having a mean length DM(ads), a mean cross section Sm of mean diameter Dm(ads) and an aspect ratio RF1 with RF1=DM(ads)/Dm(ads), and
phase change material (PCM) particles having a mean length DM(pcm), a mean cross section Sm of mean diameter Dm(pcm) and an aspect ratio RF2 with RF2=DM(pcm)/Dm(pcm),
   characterized in that:
Dm(pcm)<Dm(ads), and
RF1>1.5 and/or RF2>1.5.

### CROSS REFERENCE TO RELATED APPLICATIONS

This application is a 371 of International PCT Application PCT/FR2013/052145 filed Sep. 18, 2013, which claims priority to French Patent Application No. 1258890 filed Sep. 21, 2012, the entire contents of which are incorporated herein by reference.

### BACKGROUND

The invention relates to an adsorbent mixture composed, on the one hand, of phase change material (PCM) particles and, on the other hand, of adsorbent particles, which mixture is intended to be used in a thermocyclic adsorption separation process.

Generally, the expression “adsorbent mixture” will be considered throughout the document to mean any mixture of an adsorbent material and an additive material, optionally shaped and in variable proportions.

The expression “thermocyclic process” refers to any cyclic process during which certain steps are exothermic, i.e. accompanied by heat generation, while certain other steps are endothermic, i.e. accompanied by heat consumption.

It is known that phase change materials (PCMs) act as heat sinks at their phase-change temperature. Typical examples of thermocyclic processes for which the invention may be advantageously employed include processes that have a relatively short cycle time for which the heat transfer between the adsorbent bed and the PCM agglomerates must be carried out in only a fraction of this cycle time.

These are in particular:

pressure swing adsorption gas separation processes such as PSA (Pressure swing adsorption), VSA (Vacuum Swing Adsorption), VPSA (Vacuum

Pressure Swing Adsorption) and MPSA (Mixed Pressure Swing Adsorption);

any process employing a chemical conversion coupled to pressure swing adsorption cycles, such as those mentioned above, for shifting the equilibrium of the chemical reactions.

The pressure swing adsorption separation processes are based on the phenomenon of physical adsorption and make it possible to separate or purify gases by pressure cycling of the gas to be treated through one or more adsorbent beds, such as zeolite, activated carbon, activated alumina, silica gel or molecular sieve beds, or the like.

Within the context of the present invention, unless otherwise stipulated the expression “PSA process” denotes any pressure swing adsorption gas separation process employing a cyclic variation of the pressure between a high pressure, referred to as the adsorption pressure, and a low pressure, referred to as the regeneration pressure. Consequently, the generic expression “PSA process” is used equally to denote the following cyclic processes:

VSA processes in which the adsorption takes place substantially at atmospheric pressure, referred to as “high pressure”, i.e. between 1 bara and 1.6 bara (bara=bar absolute), preferably between 1.1 and 1.5 bara, and the desorption pressure, referred to as “low pressure”, is below atmospheric pressure, typically between 30 and 800 mbara, preferably between 100 and 600 mbara;

VPSA or MPSA processes in which the adsorption takes place at a high pressure substantially above atmospheric pressure, generally between 1.6 and 8 bara, preferably between 2 and 6 bara, and the low pressure is below atmospheric pressure, typically between 30 and 800 mbara, preferably between 100 and 600 mbara;

PSA processes in which the adsorption takes place at a high pressure significantly above atmospheric pressure, typically between 1.6 and 50 bara, preferably between 2 and 35 bara, and the low pressure is above or substantially equal to atmospheric pressure, therefore between 1 and 9 bara, preferably between 1.2 and 2.5 bara;

RPSA (Rapid PSA) processes which denote PSA processes with a very rapid cycle, in general of less than one minute.

Generally, a PSA process makes it possible to separate one or more gas molecules from a gas mixture containing them, by exploiting the difference in affinity of a given adsorbent or, where appropriate, of several adsorbents for these various gas molecules.

The affinity of an adsorbent for a gas molecule depends on the structure and on the composition of the adsorbent, and also on the properties of the molecule, especially its size, its electronic structure and its multipole moments.

An adsorbent may be for example a zeolite, an activated carbon, an activated alumina, a silica gel, a carbon or non-carbon molecular sieve, an organometallic structure, one or more oxides or hydroxides of alkali or alkaline-earth metals, or a porous structure containing a substance capable of reacting reversibly with one or more gas molecules, such as amines, physical solvents, metal complexing agents and metal oxides or hydroxides for example.

The thermal effects that result from the enthalpy of adsorption or from the enthalpy of reaction generally result in the propagation, at each cycle, of a heat wave at adsorption that limits the adsorption capacities and of a cold wave at desorption that limits the desorption.

This local cyclic phenomenon of temperature swings has a significant impact on the separation performance and the specific separation energy as mentioned in document EP-A-1 188 470.

One particular case covered within the context of the present patent is the storage of gas in and removal of gas from a reactor or adsorber at least partly containing one or more adsorbents.

Here too, a thermocyclic process involves an adsorbent material with heat release during gas storage (increase in pressure) and cold release during gas removal (decrease in pressure).

In both these cases, one solution for reducing the amplitude of the thermal swings consists in adding a phase change material (PCM) to the adsorbent bed, as described by document U.S. Pat. No. 4,971,605. In this way, the heat of adsorption and of desorption, or some of this heat, is adsorbed in latent heat form by the PCM at the temperature, or in the temperature range, of the phase change of the PCM. It is then possible to operate the PSA unit in a mode closer to isothermal.

Around ambient temperature, a hydrocarbon or a mixture of hydrocarbons may advantageously be used.

When the temperature increases, the hydrocarbon contained in the bead absorbs the heat and stores it. When the temperature decreases, the hydrocarbon contained in the bead releases the stored latent heat by changing from a liquid phase to a solid phase. During the phase change period, the temperature remains approximately constant (depending on the composition of the wax) and allows the temperature to be regulated to levels well defined by the nature of the hydrocarbon (or hydrocarbons when there is a mixture thereof) and in particular by the length of the chain and the number of carbon atoms.

For reasons of heat transfer through the phase change material itself, the latter must generally be in the form of small-size particles, generally of less than 100 microns. Mention will hereafter be made of microparticle or microcapsule to denote this base particle.

These microencapsulated PCMs cannot be introduced as such into an adsorbent bed as it would be difficult to control the distribution thereof. Furthermore, they would be entrained by the gas streams flowing through the adsorber. It is therefore necessary beforehand to produce “agglomerates”. The term “agglomerate” is understood hereafter to mean a solid with a size of greater than 0.1 mm that may adopt various forms, in particular a bead, pellet or crushed material form, obtained by crushing and screening blocks of larger sizes, or a plate form obtained by cutting precompacted sheets, or the like.

A first solution involves making an intimate mixture of the adsorbent—in powder or crystal form—and of the PCM microparticles and agglomerating the mixture. The products obtained by dry compression prove generally to be too fragile for industrial use. Agglomeration in a liquid or wet phase poses the problem of how to activate the active phase of the agglomerate. Indeed, it is known that most adsorbents have to be heated to a high temperature before use in industrial processes for achieving the required performance. The required temperature level is generally above 200° C., and often around 300 to 450° C. These temperature levels are not compatible with the mechanical integrity of the PCMs.

A second solution consists in making only PCM agglomerates, in the form of a structure that can be easily handled and introduced into an adsorber. However, the processes for manufacturing agglomerates according to the simplest current state of the art (in particular pelletizing under pressure) do not result in agglomerates with mechanical and/or thermal properties sufficient to be used effectively in thermocyclic processes.

One of the reasons for this is that the operating conditions for manufacturing these agglomerates, by the processes conventionally used to manufacture pellets of adsorbents or catalysts, are limited by the intrinsic strength of the PCMs themselves. By dint of their nature, they would be unable to withstand the pressures or temperatures needed to form strong agglomerates.

Another reason stems from the particular nature of the most conventional shell, of polymer type, and from the deformability of the capsules that results therefrom and that makes processes such as pressure agglomeration not very effective.

More precisely, the agglomerates formed by conventional means while respecting the pressure and temperature constraints inherent in PCMs are too friable for industrial applications, in particular those of the PSA type. A fraction of the agglomerates break up, thereby causing problems of poor distribution of the process fluid in the adsorber or problems of the filter being blocked by creating fine dust consisting of PCMs.

A third approach consists in integrating the PCM microparticles in a preexisting solid structure such as a “honeycomb” cellular structure or a foam, a lattice, a mesh, etc., for example by bonding to the walls. Such materials that can be produced in the laboratory cannot be used to date in large industrial units (with a volume greater than 1 m³ and more generally greater than 10 m³) not only for manufacturing or cost reasons, but also for conditions of increasing the overall porosity of the adsorbent bed and dead volume associated with the spaces not accessible to the adsorbent agglomerates (often in the form of beads, rods or crushed materials).

Hence one problem that is faced is to provide an improved adsorbent mixture that meets the criteria of stability of the mixtures, that makes it possible to increase the exchange surface area and more generally to improve the kinetics, while not increasing the pressure drop of the composite bed, and respecting the attrition rate.

### SUMMARY

One solution of the present invention is an adsorbent mixture comprising:

adsorbent particles having a mean length DM(ads), a mean cross section Sm of mean diameter Dm(ads) and an aspect ratio RF1 with RF1=DM(ads)/Dm(ads), and

phase change material (PCM) particles having a mean length DM(pcm), a mean cross section Sm of mean diameter Dm(pcm) and an aspect ratio RF2 with RF2=DM(pcm)/Dm(pcm),

characterized in that:

Dm(pcm) <Dm(ads), and

RF1>1.5 and/or RF2>1.5.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 illustrates one embodiment of the invention;

FIG. 2 illustrates another embodiment of the invention; and

FIG. 3 illustrates another embodiment of the invention.

### DETAILED DESCRIPTION

For beads and crushed materials, the two dimensional parameters may be generally considered to be equal and are easy to measure by simple means such as screening.

The problem becomes slightly more complex for extrudates. During the extrusion itself, they are characterized by the geometry of the die which gives their cross section and by their length obtained by natural breaking or by cutting (cutter, rotating blade, etc.).

If the cross section is generally cylindrical, it is possible to imagine dies of any shape, for example equilateral triangle, trilobal, ellipse, etc. but also, although a priori more uncommon, rectangular with one side substantially different from the other.

After drying and optional additional treatment, these shapes may be modified with blunt angles. At the ends, there may also be shape modifications.

It is accepted that in all cases it is possible to determine the mean cross section of the extrudates and to calculate the diameter of the circle having the same cross section either from the dimensions of the die, or by direct measurement on a representative sample of particles. Generally, the mean obtained from 25 particles is easily sufficient to be representative of the population. This diameter represents the first characteristic dimension Dm.

In the more general case of cylindrical extrudates, Dm is obviously equal to the mean diameter of the cylinder. This diameter will be very similar to the diameter of the die, to within the variations that the extrudate may undergo on leaving the die (elongation or swelling of a few %). The most common dies correspond to cylinders, the diameters of which are of the order of 5 mm, 3 mm, 2 mm, 1.5 mm, 1 mm, 0.75 mm. These dimensions are understood to within 10-15% due to the use in the first place of metric or imperial (3/16″, ⅛″, 1/16″, etc.) sizes and small modifications between the diameter of the die and the diameter of the extrudate.

With this perfectly acceptable approximation, it becomes easy to determine the first characteristic dimension of the extrudate since the geometry of the die is known, even in the case of a more complex shape.

The second characteristic dimension is the mean length of the extrudate. The direct measurement on a representative sample, a priori of 25 particles, makes it possible to determine the mean length that will be referred to as DM.

The mean values will be defined for a population having a certain distribution:

1/DM=sum (Xi/DMi) where Xi is the volume fraction of the category of particles of dimension DMi.

1/Dm=sum (Xi/Dmi) where Xi is the volume fraction of the category of particles of dimension Dmi.

For beads, crushed materials and extrudates having a length approximately equal to the thickness, the general shape may be represented by a single characteristic. In order to determine this characteristic dimension, it is generally accepted that screening (multiple screens adapted to the population) is the simplest and most common solution. Screening also makes it possible to simply calculate the mean dimension of a population having a size distribution.

As a reminder, the mean characteristic dimension De of a population is defined using the relation 1/De=sum (Xi/Di) where Xi is the volume fraction of the category of particles of dimension Di.

The aspect ratio is defined for a particle as RF=DM/Dm.

For a bead or a crushed material of which all the dimensions are approximately equal, DM=Dm and RF=1 is therefore obtained.

For a rod, a cylindrical extrudate or extrudate of equivalent shape, RF has a value greater than 1, generally greater than 2. This type of value (>2 for example) indicates that the particle is anisotropic, with one dimension greater than the others. These are generally elongated particles.

It should be noted that the characteristic dimensions of the particles within the context of this invention are determined simply: by screening for approximately isotropic particles (beads, crushed materials, etc.); by direct measurements and calculation of the equivalent diameter for elongated particles.

Depending on the case, the adsorbent mixture according to the invention may have one or more of the following characteristics:

Dm(pcm) 0.85 Dm(ads), preferably 0.50 Dm(ads)<Dm(pcm)<0.75 Dm(ads);

RF1<1.5 and RF2>1.5;

RF2<1.5 and RF1>1.5;

0.9<RF1<1.1 and RF2>1.5;

0.9<RF2<1.1 and RF1>1.5;

RF1>1.5 and RF2>1.5; the adsorbent is in the form of rods having diameters selected from the following group: 5 mm, 3 mm, 2 mm, 1.5 mm and 1 mm, and the PCM particles are in the form of rods having diameters selected from the following group: 3 mm, 2 mm, 1.5 mm, 1 mm and 0.75 mm;

the PCM particles have a shape selected from regular cylinder, cylinders with rounded ends and ellipsoid shapes, and the shape obtained by extrusion optionally followed by a spheronization step;

the ratio of the densities of the PCM particles and of the adsorbent particles is less than or equal to 2;

the PCM particles have a density of 300 to 1000 kg/m³, preferably of the order of 500 to 750 kg/m³;

the PCM particles result from a manufacturing process employing an extrusion step.

One method for determining the optimum percentages of adsorbent and of PCM has been used in the case of a large-size industrial CO₂ PSA.

Most of the charge (80% by volume) consisted of a homogeneous mixture of 20% to 25% by volume of PCM particles and 80% to 75% of standard adsorbent already tested for this same application.

The PCM particles were obtained by the fluidized bed agglomeration process and were in the form of quasi-spherical beads having a diameter ranging from 2 to 3 mm, i.e. similar to the size of the adsorbent.

This choice was made in order to be indisputably within the stability zone of the PCM/adsorbent mixture by being based on the teaching of patent FR 2 906 160 B1 which defines rules between the density ratio and the equivalent diameter ratio.

A series of tests over several weeks showed that for the longest cycle times, almost all of the expected beneficial effects were obtained, but that for the shortest cycle times it remained below expectations.

It was deduced therefrom, after eliminating other hypotheses, that the thermal efficiency of the PCM agglomerates was lower in these cases.

In order to improve the performance of a CO₂ PSA, the basic solution envisaged had been to use PCM beads having a minimum diameter with respect to the stability of the mixture, that is to say in practice having a diameter half that of the adsorbent. Taking into account the volume ratio 1 PCM/4 adsorbent, the number of PCM beads is approximately double the number of adsorbent beads whereas it was a quarter in the configuration tested.

Therefore, the points of contact between beads is multiplied, the fluid/PCM overall exchange surface area is increased and the characteristic dimension is decreased, all these points leading in the direction of a better heat exchange.

Unfortunately, comparative pressure drop measurements show a substantial increase in these pressure drops, not only because the mean diameter of the population is smaller but also and above all because the mixture of these two populations, with their respective distribution, results in greater compaction and therefore a reduction in the void fraction, a factor to which the pressure drop is very sensitive (variation with the cube of certain terms). In practice, this means that the small particles have a tendency to lodge between the largest ones and block the flow of the fluid.

In order to solve this problem, this comes down to having to make adsorbers of larger cross section, which is the opposite of what is generally desired (investment, transport, installation, volume of funds, etc.).

In the face of these negative results, additional tests were carried out with various populations of extrudates of essentially cylindrical shape and of different length to diameter ratios, as a homogeneous mixture with an adsorbent in the form of beads.

The comparison focused on the pressure drops and the attrition rate between a bed composed solely of adsorbent and composite beds.

The attrition rate was defined as the velocity of the gas passing through the bed (assumed to be empty) and causing either a de-compaction of the bed, or the setting in motion of a representative number of particles at the free surface or at the cylindrical walls.

These are visual observations. The de-compaction of the bed corresponds to an upward displacement of the free surface and a representative number of beads in motion is understood to mean a fraction of the order of 5% of the surface area. The localized movements of a few particles, in particular if they are the smallest particles at the free surface, is noted but is not taken into account. Specifically, there are simple means of limiting or eliminating these movements such as for example adding a thin layer of adsorbent alone to the free surface.

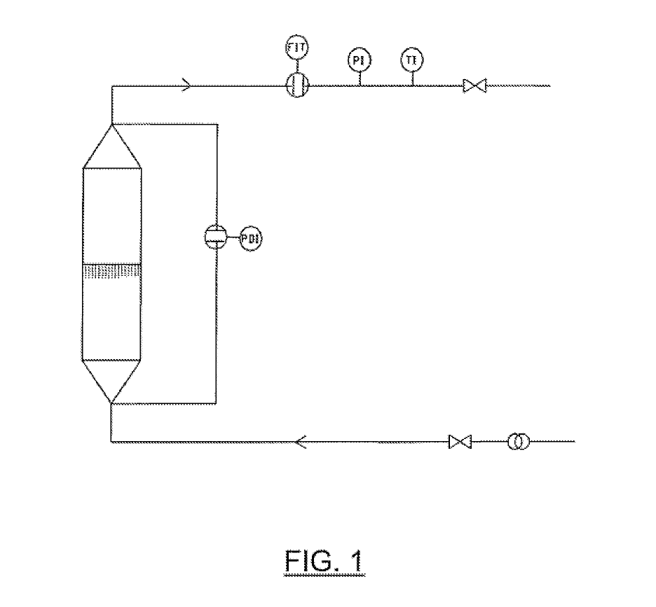

Tests were carried out with the experimental device represented schematically in FIG. 1.

In a few words, it is a transparent vertical cylinder with a diameter of 150 mm equipped with a poral (pore distributor) at its base and that may contain a particle height of the order of 0.3 to 0.4 meter. The acquisition system makes it possible to measure pressure, flow rate, temperature and pressure drop. The maximum acceptable pressure is 5 bar absolute. The gas used is cryogenic quality nitrogen.

The adsorbent or the homogeneous adsorbent/PCM mixture is introduced via a system of crossed screens in order to obtain a dense and reproducible filling.

It was observed that unlike the mixture of two families of beads of different diameters, certain mixtures at least consisting of adsorbent beads and extrudates of small diameter result in pressure drops less than or equal to those of the bed solely of beads. Similarly, the attrition rate is, for these mixtures, equal to or greater than that corresponding to the bed of beads alone.

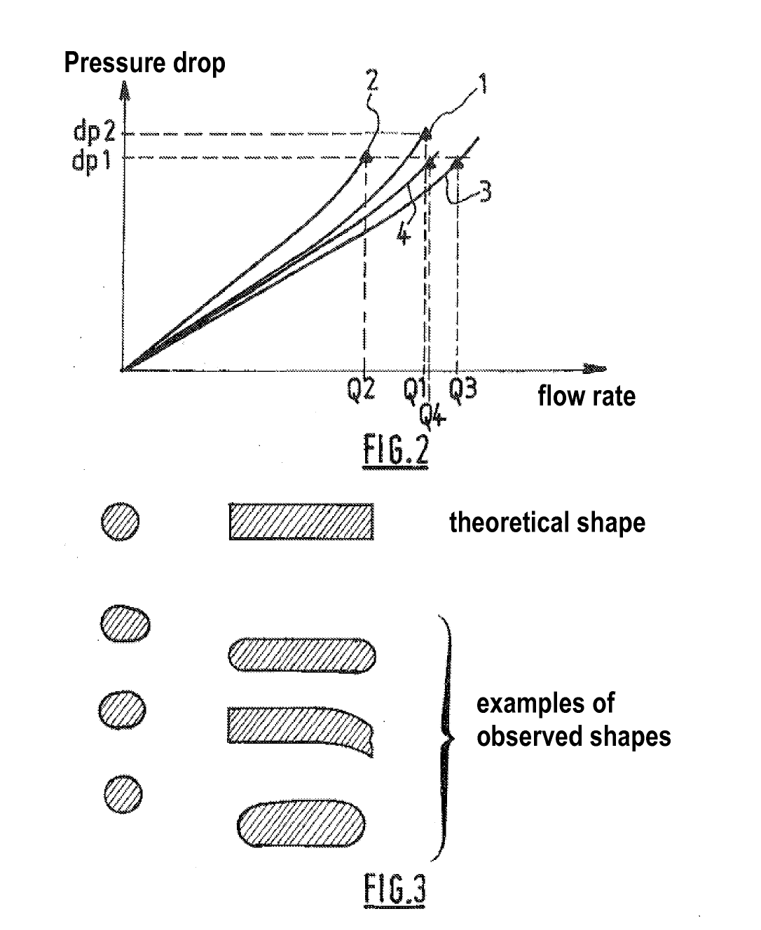

FIG. 2 illustrates the type of results obtained in a general manner. It is the measurement of the pressure drop of a flow of pure nitrogen passing through a same volume of particulate material under the same pressure and temperature conditions. The various curves have been stopped at the attrition rate (in practice, on observation of swelling of the bed in most cases).

Curve 1 corresponds to the bed of adsorbent alone (in the form of beads, crushed materials or cylinders having a length on average of less than two times the diameter). The flow rate Q1 corresponding to the attrition rate is such that the pressure drop compensates for the weight of the bed, which is a general observation.

Curve 2 corresponds to a mixture of approximately 85% by volume of adsorbent (identical to that corresponding to curve 1) and approximately 15% by volume of PCM particles of the same shape but of approximately half the size. The expression “approximately half the size” is understood to mean, for example in the case of beads, that the diameter of the PCM beads is half the diameter of the adsorbent beads; in the case of crushed materials, it is the ratio between the diameter determined by screening as explained above; in case of cylinders, it is the ratio of the diameters.

Regarding industrial production, reference is made here to the mean dimensions of the populations of particles. These definitions will be returned to later on, knowing that the shapes themselves (cylinder, sphere, etc.) are only approximations of the actual shapes.

It is observed that the mixture of 2 populations of beads—or the like—in a factor of the order of two as defined above results in a very significant increase (from 10% to more than 30%) of the pressure drop at given operating conditions and flow rate. Although the bed is more compacted, the fact that the PCM particles have a lower density in these tests than the adsorbent particles, the attrition rate as defined is generally obtained for a slightly lower pressure drop.

The maximum flow rate Q2 (or Q2′) remains substantially lower than the maximum flow rate Q1, generally more than 15% lower.

By visual observation, it is observed that the small particles preferentially lodge in the spaces left by the large ones and tend to thus block the flow of the gas.

This phenomenon of reduction of the interstitial void fraction was known but no solution for solving it had been provided up to now.

It was observed that this blocking effect could be eliminated by using PCM particles, still of small size in order to be effective but of different shape, in particular using elongated cylindrical shapes.

It was thus possible to obtain for the mixture similar pressure drops (curve 4) or substantially lower pressure drops (curve 3). The latter mixture leading to a void fraction greater than the void fraction of the adsorbent alone and to a lower density is not, in most cases, the most advantageous one for PSA application but may be useful in specific cases (reduction of the pressure drops, etc.).

Regarding, in this test, measurements of hydraulic type (pressure drops, flow rate, velocity, etc.) and not of thermal performance or of adsorption, these observations remain valid whether the most elongated particles are PCM particles or adsorbent particles. Thus the aspect ratio to be complied with (>1.5) may apply with our notations to RF1 or to RF2.

The advantage of using PCM particles of small dimensions, i.e. having an individual volume smaller than the mean volume of the adsorbent particle, has also been demonstrated by comparing the thermal swings of various adsorbent/PCM mixtures.

The tests consist here in carrying out PSA cycle tests with mixtures of 80% by volume of adsorbent and 20% by volume of PCM particles. Various sizes of PCM particles are tested while the adsorbent is always the same.

The simplest significant parameter to measure is the thermal swing during the cycles. The expression “thermal swing” is understood to mean the difference between the maximum and minimum temperatures recorded over a cycle. A perfectly isothermal cycle would give a swing equal to zero. By accelerating the cycle, i.e. in practice by treating a greater flow rate, it is observed for mixtures comprising the largest PCM particles that the swings increase, an indication that the PCM particles no longer have sufficient effectiveness or at the very least have a reduced effectiveness. This is what was observed regarding the industrial PSA mentioned above. Conversely, with the smallest particles, the swings remain constant showing that the PCM particles have retained their effectiveness with a reduced cycle time. The measurements of productivity between the various tests confirm that the mixtures with small-size PCM particles are more effective, all the more so as the cycle is rapid.

The tests with beads and rods show that in order to improve the thermics, it is advisable to use small PCM particles, i.e. particles having a volume and/or characteristic dimension smaller than the adsorbent particles.

Other specific tests show that in order to retain acceptable pressure drops, attrition rate and void fraction, it is furthermore advisable to use particles of very different geometric shape as long as one population has a size substantially smaller than the other.

In practice, it is observed that PCM rods having a mean diameter Dm(pcm) smaller than the diameter of the adsorbent, for example by a factor of 1.5 to 3 and having a mean length DM(pcm) in the range extending from 2 to 8 times the mean diameter Dm(pcm) are a good compromise between the various constraints.

Industrially, it should be noted:

that the particles, whether they are adsorbent or PCM particles, are not all of the same size but that their characteristics (diameter, length, thickness, etc.) are statistically distributed about mean values;

that the shapes themselves do not correspond to simple geometric figures (sphere, cylinders) but are more complex. FIG. 3 shows, by way of example, some of the shapes actually observed with respect to the theoretical cylindrical shape. The various particles exhibit variations around a common general shape. Similarly, the spheres are not perfect but are of ellipsoidal or even potato-like shape.

A large number of shapes may also exist for the extruded particles depending on the die (geometric shape of the cross section), the manner in which the extrudates are segmented (by the simple effect of gravity, by a blade, etc.) and the subsequent treatment (partial spheronization, drying).

Existing industrial PCMs that may be used within the context of the present invention are in the form of microcapsules which are then agglomerated, as explained below.

The phase change materials or PCMs by themselves may be organic, such as paraffins, fatty acids, nitrogen-containing compounds, oxygen-containing compounds (alcohol or acids), phenyls and silicones, or inorganic, such as hydrated salts and metal alloys. They are generally microencapsulated in a micron-sized solid shell, preferably based on polymers (melamine formaldehyde, acrylic, etc.).

Since paraffins in particular are relatively easy to microencapsulate, they are generally the PCMs of choice compared to hydrated salts, even if the paraffins have a latent heat generally lower than those of hydrated salts. Furthermore, paraffins have other advantages such as the reversibility of the phase change, chemical stability, phase change temperature or phase change temperature range that are defined (no hysteresis effect), a low cost, limited toxicity and the wide range of phase change temperatures available depending on the number of carbon atoms and the structure of the molecule. Microencapsulated paraffinic PCMs are in the form of a powder, each microcapsule constituting this powder being between 50 nm and 100 μm in diameter, preferably between 0.2 and 50 μm in diameter. For reasons described in patent FR 2 906 160 B1, the PCMs cannot be used as is since, due to their small size, they would be irreversibly entrained by the circulating fluid, i.e. the gas to be treated.

In order to retain the advantage linked to the thermal performance of PCMs, it is advisable to make agglomerates thereof that are mechanically strong enough for the use thereof in a PSA process while using a minimum of binder, of less than 30% by volume, preferably less than 10%, more preferably less than 5% by volume.

Advantageously, this binder, if it proves necessary for obtaining the agglomerates, is at least as heat conductive as the PCM in the liquid state in order not to significantly limit the heat exchanges. By way of example, this binder may be a clay (bentonite, attapulgite, kaolinite, etc.) or a hydraulic binder of cement type or else a polymer, preferably that melts at low temperature (below 120° C.), or else an adhesive or a resin, optionally an adhesive or a resin with improved thermal conductivity, i.e. for example containing metals (Fe) or graphite, or else simple fibers or powders that improve the behavior of the whole assembly (carbon fibers, metal powders, etc.).

Within the context of the invention, the use, in the manufacturing process, of an extrusion step that comprises passing a paste comprising PCM microparticles through an extruder makes it possible to quite accurately control the aspect ratio of the agglomerates obtained and also the parameters defined in patent application WO 2008/037904 (mean diameter, density) make it possible to obtain a homogeneous and stable mixture of PCM particles and adsorbent particles (namely, for example, a density ratio of less than 3 and a diameter ratio of less than 2).

The extrudates composed mainly of PCMs are obtained mainly in the form of rods produced via an agglomeration process using at least one extrusion step such as that described in U.S. Pat. No. 7,575,804 B2 (Basf, Lang-Wittkowski et al. 2009) and PCT WO 02/055280 A1 (Rubitherm GMBH, 2002) although other shapes are possible.

In order to carry out the shaping of PCMs complying with all the constraints mentioned above, one or more of the following steps of a manufacturing process are used:

the microparticles are of spheroid shape and have a mean diameter of between 1 and 25 microns;

at the end of the extrusion step extrudates are recovered in the general shape of rods and having a mean diameter of between 0.1 and 10 mm, preferably between 0.3 and 5 mm;

during the extrusion step, use is made of an extrusion pressure of less than 10 MPa, preferably of between 5 MPa and 8 MPa, more preferably of less than 5 MPa;

the paste comprising the PCM particles remains at a temperature below 100° C., preferably below 80° C. during the extrusion step;

said process comprises, downstream of the extrusion step, a step of drying the extrudates recovered at the end of the extrusion step;

said process comprises, upstream of or at the same time as the drying step, a step of spheronization of the extrudates recovered at the end of the extrusion step. The final agglomerate will preferably be in the form of a spheroid having a mean diameter of between 0.1 mm and 10 mm, preferably of between 0.3 and 5 mm;

said process comprises, upstream of or at the same time as the drying step, a step of coating the extrudates recovered at the end of the extrusion step;

the coating step is such that the thickness of the coating formed around the extrudates is between 0.001% and 10% of the diameter of the agglomerate recovered at the end of the process;

the spheronization, drying and coating steps are preferably carried out in a fluidized bed;

the binder is selected from cellulosic polymers, vinyl/acrylic copolymers, carboxyvinyl polymers, water glass (sodium silicate, more specifically sodium metasilicate), polyethylene glycols 4000, polyvinyl acetates; the binder is preferably selected from hydroxypropyl celluloses (HPC) and/or sodium carboxymethyl celluloses (Na-CMC).

It is noted that the paste may also comprise solid additives. These additives may be organic and/or inorganic. They may be a material having a thermal conductivity of greater than 1 W/m/K, capable of increasing the thermal conductivity of the agglomerate, preferably a metallic compound or graphite in the form of powder or filaments.

It is noted that the paste may also comprise solid additives that have ferromagnetic properties enabling a separation, by magnetization, of PCM agglomerates from adsorbent particles with which these PCM agglomerates might be mixed. The ferromagnetic materials (in particular iron powder) make it possible at the same time to modify the density of the extrudate and to ensure the stability of the PCM-adsorbent mixture during operation of the adsorption separation unit. The additives have a maximum dimension (diameter or length) of between 1 and 100 microns, preferably between 10 and 50 microns.

According to additional characteristics, the agglomerate will contain between 50% and 99% by weight of PCM microcapsules. Preferably, the PCM microparticles represent from 50% to 99.5% by weight of the dried final particle, the solid additive from 0 to 50% by weight and the binder less than 5% by weight.

In addition to having to obtain PCM particles having a diameter and density that make possible a homogeneous and stable mixture (namely for example a density ratio of less than 3 and a diameter ratio of less than 2 according to the teaching of patent application WO 2008/037904), the attrition resistance, the compression strength, etc. must not constitute the weak point of the mixture. By way of example, it could thus be said that the attrition resistance should not be more than a factor of 2 lower than that of the jointly used adsorbent. The same applies for the compression strength. It is not possible to give a target value in absolute terms for these characteristics knowing that they depend completely on the adsorbent (activated alumina, zeolite, etc.), on its dimensions, on its state (degree of moisture for example) and also on the way in which these characteristics are measured. The “supplier” values of these properties are found in the technical specifications that they publish. It will finally be noted that the geometry of the container of these particles (adsorbent, reactor) and the operating conditions contribute to setting the minimum properties required.

Another constraint originates from the fact that it is necessary to retain the integrity of the PCM particles during the manufacturing process. Said microparticles must, as explained above, be able to withstand the pressure necessary for the extrusion, and the temperature reached in the die. They must also be insoluble in the solution containing the binder which must additionally give the mixture sufficient consistency and plasticity.

This has been able to be obtained by selecting PCMs having a certain number of characteristics of dimensions, of mechanical strength at temperature and pressure and of surface finish.

The PCMs are in the form of microbeads coated with a polymer that forms an impermeable shell that is insoluble in water (hydrophobic). Said microencapsulation is generally obtained by phase inversion of an emulsion according to processes known to a person skilled in the art.

The shell must preferably retain more than 50% of its mechanical properties measured at ambient temperature up to a temperature of 80° C. or even 100° C.

The phase change material used, which depends on the application for which the PCMs are intended, is a mixture of linear saturated hydrocarbons with the number of carbon atoms varying between 14 and 24.

The estimated compression strength is greater than several MPa, which would place this product in the range of potential extrusion pressures.

One commercial example of a PCM corresponding to this description is the product Micronal® from BASF.

A paste having a rheological characteristic that enables extrusion has been obtained by using a solution consisting of a solvent, a binder and, depending on the respective contents of the latter, an additive of thickener type and/or a surfactant.

More generally, the “binder” will be selected from cellulosic polymers (cellulose-based polymers), in particular hydroxypropyl celluloses (HPC) or sodium carboxymethyl celluloses (Na-CMC), vinyl/acrylic copolymers, carboxyvinyl polymers (CLPs), water glass, PEGs 4000, PVAs.

The solvent is preferably pure water but it is not necessary to completely demineralize it.

An emulsion of polyvinyl acetate latex as additive facilitates the extrusion in certain cases by improving the rheology of the solution (viscosity, plasticity, etc.).

The content of the binder in the solvent solution may range in general from 1% to 50% by weight, more particularly from 1% to 20% by weight, depending on the products used.

On a dry basis, it was possible to obtain extruded particles comprising more than 99% by weight of PCM and consequently less than 1% of binder.

These values were obtained from a paste containing less than 10% by weight of solvent in which there was also less than 10% by weight of binder.

Extrudates were also produced from two different samples of PCM, PCM1 and PCM2 (difference in diameters respectively centered about 5 and 10/15 microns, etc.).

Depending on the manufacturing methods, up to 40% by weight of graphite and 10% by weight of iron powder were added.

Other subjects of the present invention are an adsorber comprising at least one adsorbent bed composed of an adsorbent mixture according to the invention and an adsorption unit comprising at least one such adsorber.

The adsorption unit may be an H₂ PSA, a CO₂ PSA, an O₂ PSA, an N₂ PSA, a CH₄ PSA, a helium PSA, etc. (A “constituent X” PSA refers to a PSA of which the objective is to produce or extract said constituent from the feed gas.)

It is noted that if the adsorption unit comprises a fixed bed, this bed may comprise one or more layers of adsorbent, commonly referred to as a multi-bed in technical language.

The invention therefore relates to the majority of PSA processes and more particularly in a nonlimiting manner, besides the H₂, O₂, N₂, CO and CO₂ PSA processes, the PSA processes for fractionating syngas into two fractions at least, the PSA processes on natural gas intended to remove the nitrogen, and the PSA processes that are used to fractionate mixtures of hydrocarbons.

The invention may be implemented, in addition, in:

an argon PSA process as described in particular in U.S. Pat. No. 6,544,318, U.S. Pat. No. 6,432,170, U.S. Pat. No. 5,395,427 or U.S. Pat. No. 6,527,831. Ar PSA makes it possible to produce oxygen having a purity of greater than 93%, by preferentially adsorbing either argon, or oxygen, present in an O₂-rich stream resulting for example from an O₂ PSA. Ar PSA processes generally use a carbon molecular sieve or a silver-exchanged zeolite (U.S. Pat. No. 6,432,170);

an He PSA process that makes it possible to produce helium by preferentially adsorbing the other molecules present in the feed stream;

any PSA process that enables the separation between an alkene and an alkane, typically ethylene/ethane or propylene/propane PSA processes, for example. These separations are based on a difference in the adsorption kinetics of the molecules on a carbon or non-carbon molecular sieve;

any PSA process that makes it possible to fractionate a synthesis gas (syngas);

any PSA process that makes it possible to separate CH₄ from N₂.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1-14. (canceled)

15. An adsorbent mixture comprising:
adsorbent particles having a mean length DM(ads), a mean cross section Sm of mean diameter Dm(ads) and an aspect ratio RF1 with RF1=DM(ads)/Dm(ads), and
phase change material (PCM) particles having a mean length DM(pcm), a mean cross section Sm of mean diameter Dm(pcm) and an aspect ratio RF2 with RF2=DM(pcm)/Dm(pcm), wherein:
Dm(pcm)<Dm(ads), and
RF1>1.5 and/or RF2>1.5 the adsorbent particles and/or the PCM particles being in the form of rods.

16. The adsorbent mixture of claim 15, wherein Dm(pcm) 0.85 Dm(ads), preferably 0.50 Dm(ads)<Dm(pcm,≦0.75 Dm(ads).

17. The adsorbent mixture of claim 15, wherein RF1<1.5 and RF2>1.5.

18. The adsorbent mixture of claim 15, wherein RF2<1.5 and RF1>1.5.

19. The adsorbent mixture of claim 15, wherein 0.9<RF1<1.1 and RF2>1.5.

20. The adsorbent mixture of claim 15, wherein 0.9<RF2<1.1 and RF1>1.5.

21. The adsorbent mixture of claim 15, wherein:
RF1>1.5 and RF2>1.5;
the adsorbent is in the form of rods having diameters selected from the following group: 5 mm, 3 mm, 2 mm, 1.5 mm and 1 mm, and
the PCM particles are in the form of rods having diameters selected from the following group: 3 mm, 2 mm, 1.5 mm, 1 mm and 0.75 mm.

22. The adsorbent mixture of claim 15, wherein the PCM particles have a shape selected from regular cylinder, cylinders with rounded ends and ellipsoid shapes, and the shape obtained by extrusion optionally followed by a spheronization step.

23. The adsorbent mixture of claim 15, wherein the ratio of the densities of the PCM particles and of the adsorbent particles is less than or equal to 2.

24. The adsorbent mixture of claim 15, wherein the PCM particles have a density of 300 to 1000 kg/m3, preferably of the order of 500 to 750 kg/m3.

25. The adsorbent mixture of claim 15, wherein the PCM particles result from a manufacturing process employing an extrusion step.

26. Adsorber comprising at least one adsorbent bed composed of an adsorbent mixture of claim 15.

27. An adsorption unit comprising at least one adsorber as claimed in claim 26.

28. The adsorption unit of claim 27, wherein said unit is selected from an H2 PSA, a CO2 PSA, an 02 PSA, an N2 PSA, a CO PSA, a CH4 PSA or a helium PSA.
